(19) United States
(12) Patent Application Publication
(10) Pub. No.: US 2024/0322860 A1
(43) Pub. Date: Sep. 26, 2024

(54) APPARATUS FOR AUDIO TRANSMISSION FOR A SPORTS FIELD

(71) Applicant: Ennio PANELLA, Arsiè (IT)

(72) Inventor: Ennio PANELLA, Arsiè (IT)

(21) Appl. No.: 18/273,503

(22) PCT Filed: Oct. 13, 2022
(86) PCT No.: PCT/IB2022/059814

§ 371 Date: Jul. 20, 2023

(30) Foreign Application Priority Data
Oct. 14, 2021 (IT) 102021000026354

(51) Int. Cl. H04B 5/26; H04R 1/10; H04R 3/12

(52) U.S. Cl. CPC H04B 5/26; H04R 1/1016; H04R 1/1041; H04R 3/12; H04R 2420/07

(57) ABSTRACT

It is provided an apparatus for audio transmissions (1) for a sports field (4): an inductive loop (2) for audio disposed around said sports field (4), a plurality of listening earphones (3), of the inductive in-ear type and configured to be used with the inductive loop (2), each of the listening earphones (3) comprising: an ergonomic tubular element (30), suitable for insertion into the ear canal, comprising: sound emitting means (31), a battery (32), transmission means (33) and receiving means in a radio frequency Wireless mode, comprising an elongated body (34) protruding from said ergonomic tubular element (30) capable of acting as a receiving antenna and as a handle for insertion and extraction into the ear canal.

The present invention relates to an apparatus for audio transmission for sports field. In particular, it relates to use for the practice of sporting activity in a delimited field of a transmission apparatus according to the preamble of claim 1.

It is now well known that human beings have an extremely complex auditory apparatus, which enables us to perceive sound stimuli.

Although, for this purpose, all kinds of listening articles are now commonly available on the market (e.g. wired headphones, wireless headphones with various types, etc.). The function of common headphones of various types for listening still remains incomparable and irreplaceable today, provided, however, that they are used correctly.

The common wireless listening headset, as things stand today, can be based on at least three different communication standards and includes, as is well known, Bluetooth (BT), radio frequency (RF) and infrared (IR). Today, the most widespread, as well as the most versatile, are the Bluetooth headsets, which have a range of up to 10 metres and can connect to most devices equipped with the same type of technology (Smartphone, Tablet, PC, TV, etc.), without the need for external receivers, while radio frequency headsets have a range of up to 100 metres, all of which require an external transmitter to make them work, while infrared headsets have a very limited range. The end result for group sportsmen and women is unsuitable, especially with communication between the football pitch and the bench being very crucial. Conversely, the coach should have a radio-frequency base to transmit to the player's micro mono-ear to hear the right instructions from his coach.

In this situation, the technical task at the basis of the present invention is to devise an apparatus for sports field audio transmissions that can substantially obviate at least part of the aforementioned drawbacks.

It is also a further aim of the present invention to provide a group listening device that allows for more effective and user-focused listening, in particular voice or sounds of preference, for sportsmen and women active listening is the main tool of psychotherapy and, more generally, of helping relationships. However, it can become a special ally, especially in the daily training of both amateur and professional sportspeople, to brilliantly overcome technique, which in sport refers to a set of motor schemes used to solve a sporting task, for example: in football, basketball volleyball, handball, rugby, etc., adapt quickly and optimally to the contingent technical-tactical situation so as to disorganise the opponent's technique as much as possible while keeping one's own very effective.

Hence, to avoid very common mistakes that contribute to forming ‘barriers’ that bring each of the athletes the experience of:
Becoming more careful in the game, with more professionalism,
Mastering the technique of empathic mirroring, i.e. a system for quickly creating rapport with our interlocutor, based on trust and harmony of the technique.
Weakening of the hearing apparatus known as ‘hearing loss’ due to damage or degeneration of one or more of its components.

It is therefore an object of the present invention to provide a mono-earpiece called “in-ear” that is capable of reproducing excellent comfort and correct listening without effort, innovative in design and functionality, has a wireless radio frequency connection, is made of water-repellent material, treated with substances that make it impenetrable to water, so that even for sports such as sportsmen of the swimming ball, will be able to take advantage of this new technology.

It is also the aim of the present invention to provide a listening device that is comfortable, lightweight and feels comfortable in any situation, easy to use and with a high level of noise suppression, suitable for and made of materials specially designed to let through the frequencies of listening, if desired also of speech and game sound signals such as the referee's whistle. This is to ensure maximum comfort and safety for the sports user, while at the same time being space-saving and with very low production costs.

The specified technical task and purposes are achieved by a sports field audio transmission apparatus as claimed in the appended claim 1.

These and other purposes are preferably achieved by the present listening device preferably comprising:
Single radio frequency Wireless hearing earpiece;
Battery;
Inductive loop, capable of transforming the automatic hearing device connection with an audio system, allowing, in a wide enabled zone, perfect hearing of the person who is transmitting.

In accordance with the present invention, the wireless in-ear mono earphone is a Wireless micro-mini inductive remote receiver that changes sound signals via electromagnetic fields. This latest generation earpiece is small in size, consumes less energy, has a longer lifetime, and has a much clearer sound. By using this radio-frequency device, it is possible to hear the coach's single voice in all group headsets within a suitable range for communication, so that the coach can give game directions in the best possible way and also increase the performance of individual athletes.

Advantageously, an example battery type 337 SR416SW is provided, with great power for small devices, ensuring a longer battery life and long-lasting power supply, with a diameter of only 4.8 millimetres.

In addition, the mini radio-frequency wireless in-ear receiver single earphone is very small (6×6×10 mm), has a perfectly ergonomic shape and is based on a transmitter with an antenna that is connected to the output of the device from which the sound comes and which converts the radio signal into an electrical signal.

Advantageously, we can say that Wireless mono earphone are based on radio waves and are able to receive signals using an antenna installed on a small receiver or near sports fields, and their range varies depending on the type of system used to transmit the signal to all the mono earphones in the group, having the same frequency in reception and, if desired, also in transmission. The expert in the field will therefore be able to select the mono earphone and the hearing technology deemed most suitable for the invention.

Further features and advantages of the mono earphone according to the invention will become clearer with the following description of certain embodiments, made by way of example and not limitation, with reference to the appended drawings, wherein:

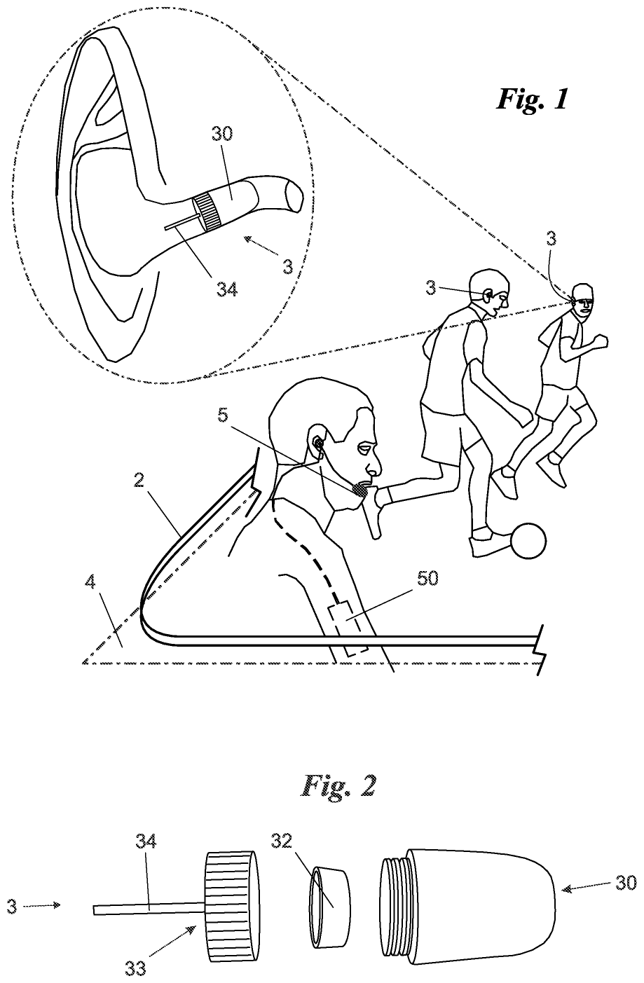

the FIG. 1 shows in a schematic manner, with relative schematic enlargement and section, an apparatus for audio transmissions in a sports field according to the invention;

the FIG. 2 shows an exploded view of a component part of the apparatus according to the invention.

With reference to the appended figures, there is thus described an apparatus for audio transmissions, globally referred to as number 1.

It preferably comprises an audio induction loop system placed in a sports field 4, i.e. a field for the practice of a sporting activity such as football, rugby, ball sports or similar.

The induction loop systems are a listening technology generally used for people with reduced hearing.

It comprises, in summary, an induction loop for audio 2 and a plurality of listening devices 3.

The induction loop system, or inductive audio implants, sometimes referred to as induction transmitters, are a well-known technology and present, even by regulation in many countries, for assistive listening in defined areas.

The induction loop system works by creating an alternating magnetic field in the inductive loop for audio 2 frequencies, which provide an input signal for inductive in-ear listening devices 3, also referred to as Telecoils or T-coils.

For example, the inductive loop for audio 2 is placed around the sports field 4 and delimits its ring perimeter. It is basically a cable made of conductive material such as copper or similar.

The inductive loop for audio 2 is functionally connected with a dedicated microphone 5 to capture the voice of a speaker, in this case preferably the coach.

When the sound source is captured the audio signal from the microphone 5 is transferred to a transmission device 50 such as an amplifier.

An electric current is then delivered into the inductive loop for audio 2 which, at the same time, creates a magnetic field that transmits an audio frequency. The loops carry baseband audio frequency currents; no carrier signal is used. The said magnetic field induces a current in transmission means 33, included in the listening earphones 3 and described below, which is then translated into audio by the same listening earphones 3.

The inductive loop for audio 2 is inherently familiar to the hearing systems engineer. Similar inductive loops for audio are described in IEC 60118-4 and BS 7594.

Said hearing devices 3 are preferably mono-earphones and comprise an ergonomic tubular element 30, suitable for insertion into the ear canal. The ergonomic tubular element 30 is of a rubberised adherent type. It is preferably fitted with an ergonomically contoured moulding designed to be completely concealed in the ear canal to be used for the purpose of improving this functionality when listening. As illustrated in the enlargement and section in FIG. 1, it is intended to be housed in the ear canal.

The ergonomic tubular element 30 comprises, in turn, sound emitting means 31, which are known and suitable for emitting sound in a manner that can be clearly heard by the listener.

The ergonomic tubular element 30 further comprises a battery 32, suitable for powering the various elements included in the listening earphone 3, such as, for example, an amplifier of the signal transmitted by the inductive loop.

The listening earphone device 3 further comprises transmission means 33 and reception in wireless radio frequency mode. They thus comprise an induction coil capable of receiving the electromagnetic signal realised by the inductive loop for audio 2. Said transmission means 33 are suitably connected to, or directly comprise, an elongated body 34 protruding from said tubular element 30 acting as a receiving antenna and a handle for insertion and extraction in the ear canal.

Preferably the microphone 5 is used by a coach a manager or similarfigure capable of leading the team, while the earphones 3 are used by individual athletes on the playing field 4.

The coach can then manage his sports group or even individually with more professionalism.

In another possible embodiment of the invention, it may provide that the receiving volume refers to the listening volume. Increasing the receive volume causes the audio received by the caller to be louder for the listener and does not affect the manner in which the user's voice is transmitted to the caller.

The device has the advantage of allowing the sound source of interest to be transmitted to the listener clearly and without other distracting noises in the environment.

It also does not cause radiation from frequencies typical of electromagnetic signals such as Bluetooth® and similar.

1. An apparatus for audio transmission for a sport field comprising:
an inductive loop for audio arranged around said sports field;
a plurality of listening earphones, of an inductive in-ear type and configured use with said inductive loop, wherein
each of said listening earphones include
an ergonomic tubular element, suitable for insertion in the ear canal, comprising:
a sound emitting means;
a battery; and
a transmission means and receiving in wireless radio frequency mode, comprising an elongated body protruding from said ergonomic tubular element suitable for acting as a receiving antenna and as a handle for insertion and extraction in the ear canal.

2. The apparatus for audio transmission according to claim 1, wherein said transmission means comprise an induction coil capable of receiving an electromagnetic signal realized by said inductive loop for audio.

3. The apparatus for audio transmission according to claim 1, wherein said induction coil is integral with said elongated body.

4. The apparatus for audio transmission according to claim 1, wherein said induction coil is said elongated body.

5. Use for sporting activity in a sports field of the audio transmission apparatus according to claim 1, wherein said sports field is surrounded by said inductive loop.

6. An audio transmission apparatus for a sports field comprising:
a wireless transmitter for audio in Bluetooth® LE technology or smartphone with compatible technology placed at one or more edges of said sports field, a plurality of listening devices, of wireless in-ear type in Bluetooth® LE technology and configured to be used with said wireless transmitter, each of said ear listening devices comprising:
an ergonomic tubular element, suitable for insertion into the ear canal, comprising:
a means of sound emission;
a battery;
a transmission and reception means in Bluetooth® LE technology, comprising an elongated body protruding from said ergonomic tubular element capable of acting as a receiving antenna and as a handle for insertion and extraction into the duct auditory.

7. The audio transmission apparatus of claim 6, wherein said transmission means comprise an antenna suitable for receiving an electromagnetic signal constructed by said wireless audio transmitter.

8. Use for the practice of sporting activity in a sports field of the audio transmission apparatus according to claim 1, wherein said sports field is accompanied by said wireless audio transmitter.

9. Use for the practice of sporting activity in a sports field of the audio transmission apparatus according to claim 6, wherein said sports field is accompanied by said wireless audio transmitter.

10. The apparatus for audio transmission according to claim 2, wherein said induction coil is integral with said elongated body.

11. The apparatus for audio transmission according to claim 2, wherein said induction coil is said elongated body.

12. The apparatus for audio transmission according to claim 3, wherein said induction coil is said elongated body.

13. Use for sporting activity in a sports field of the audio transmission apparatus according to claim 2, wherein said sports field is surrounded by said inductive loop.

14. Use for sporting activity in a sports field of the audio transmission apparatus according to claim 3, wherein said sports field is surrounded by said inductive loop.

15. Use for sporting activity in a sports field of the audio transmission apparatus according to claim 4, wherein said sports field is surrounded by said inductive loop.

16. Use for the practice of sporting activity in a sports field of the audio transmission apparatus according to claim 2, wherein said sports field is accompanied by said wireless audio transmitter.

17. Use for the practice of sporting activity in a sports field of the audio transmission apparatus according to claim 3, wherein said sports field is accompanied by said wireless audio transmitter.

18. Use for the practice of sporting activity in a sports field of the audio transmission apparatus according to claim 4, wherein said sports field is accompanied by said wireless audio transmitter.

19. Use for the practice of sporting activity in a sports field of the audio transmission apparatus according to claim 5, wherein said sports field is accompanied by said wireless audio transmitter.
